(19) United States
(12) Patent Application Publication
(10) Pub. No.: US 2026/0076859 A1
(43) Pub. Date: Mar. 19, 2026

(54) AMBULATORY AID

(71) Applicant: Ernest Pulver, Nanaimo (CA)

(72) Inventor: Ernest Pulver, Nanaimo (CA)

(21) Appl. No.: 18/888,662

(22) Filed: Sep. 18, 2024

(51) Int. Cl. A61H 3/04

(52) U.S. Cl. CPC A61H 3/04; A61H 2201/0192

(57) ABSTRACT

An ambulatory aid that is operable to assist a user move from a seated position to a standing position wherein the present invention further assists a user in walking subsequent being in a standing position. The aid includes a frame having a lower frame member and an upper frame member. The frame includes a first side and a second side wherein the first side and second side are identically constructed. A seat member is intermediate the first side and second side of the lower frame member. The upper frame member is movably coupled to the lower frame member wherein the upper frame member is configured to move in an upwards-downwards movement. A motor is provided that is operably coupled to the upper frame member and controlled with a controller by the user. The frame includes wheels on opposing corners thereof.

### FIELD OF THE INVENTION

The present invention relates generally to mobility assistance devices, more specifically but not by way of limitation, a rollator style mobility assistance device wherein the present invention includes an upper frame member that is movable in vertical direction so as to provide assistance to a user moving from a sitting position to a standing position.

### BACKGROUND

Many individuals have trouble walking either due to a recent medical procedure or as a result of chronic injuries/conditions. There are various types of ambulatory aids that are utilized in the field to provide assistance for a user in walking or moving from one location to another. Devices such as but not limited to canes, crutches and wheeled devices are known in the art and utilized to assist a user in walking. Some individuals require more balance assistance and as such it is common for these individuals to utilize devices such as walkers. Conventional walkers have a frame that provides four points of contact around a user so as to ensure the stability of a user during use thereof.

Many conventional walkers, also referred to as rollators, have a full frame with two to four wheels configured to engage the ground. These devices are also commonly provided with a seat so as to allow the user to move to a sitting position once the user has reached the desired location. Convention designs provide brakes to lock the wheels and provide stability when the user is moving from the sitting position to the standing position. One issue with conventional walker/rollators is the height of the handles. While the handle height is acceptable for the walking position, they do not provide a good leverage point for assisting a user in moving from the sitting position to the standing position.

Accordingly, there is a need for a rollator walker style device that is configured to have an upper frame member wherein the upper frame member is movably through motorized technique in a vertical direction so as to provide assistance in moving a user from a sitting position to a standing position.

### SUMMARY OF THE INVENTION

It is the object of the present invention to provide a mobility assistance device that is configured to assist a user in walking wherein the present invention includes a frame.

Another object of the present invention is to provide a rollator style walker operable to assist a user with mobility wherein the frame of the present invention includes a lower frame and an upper frame.

A further object of the present invention is to provide a mobility assistance device that is configured to assist a user in walking wherein the lower frame can be configured with a seat member that is intermediate opposing sides of the lower frame.

Yet a further object of the present invention is to provide a rollator style walker operable to assist a user with mobility wherein the upper frame is movably secured to the lower frame.

Still another object of the present invention is to provide a mobility assistance device that is configured to assist a user in walking wherein the upper frame is operable to move in a vertical direction with respect to the lower frame

An additional object of the present invention is to provide a rollator style walker operable to assist a user with mobility wherein the upper frame further has operably secured thereto at least one control unit.

Yet a further object of the present invention is to provide a mobility assistance device that is configured to assist a user in walking wherein the present invention includes a motor configured to operate the upper frame and wheels.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention with the upper frame in a first position; and

FIG. 2 is a perspective view of the present invention with the upper frame in a second position.

### DETAILED DESCRIPTION

Referring now to the drawings submitted herewith, wherein various elements depicted therein are not necessarily drawn to scale and wherein through the views and figures like elements are referenced with identical reference numerals, there is illustrated an ambulatory aid 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the ambulatory aid 100 includes a frame 5 wherein the frame 5 is comprised of a lower frame member 10 and an upper frame member 15. The frame 5 is manufactured from a suitable material such as but not limited to tubular metal. It should be understood while an embodiment of the frame 5 is illustrated herein that the frame 5 could be constructed in alternate shapes and sizes and still provide the desired functionality discussed herein. Furthermore, it is contemplated within the scope of the present invention that elements such as but not limited to the wheels 95 could have movable extension mounts, particularly for the two rear wheels to provide stability during use of the ambulatory aid 100.

The lower frame member 10 includes a first side 11 and second side 12. The first side 11 and second side 12 are identically constructed and have a seat member 20 operably coupled intermediate thereto. The first side 11 is comprised of first horizontal support member 30 having a first end 31 and second end 32. The first horizontal support member 30 is intersected by and operably coupled to the first vertical support member 35. The first vertical support member 35 includes first end 36 and second end 37. First vertical support member 35 is perpendicular with the first horizontal support member 30 with the majority portion thereof extending upward therefrom. The first side 11 further includes front support member 40 wherein the front support member 40 is arcuate in form. The front support member 40 has an end operably coupled to the first vertical support member 35 and an opposing end configured to have a wheel 95 operably coupled thereto. A rear support member 50 is operably coupled to the first vertical support member 35 opposite the front support member 40. The rear support member 50 is operably coupled to the first vertical support member 35 at a first end and the opposing end is configured to have a wheel 95 operably coupled thereto. The rear support member 50 is similarly arcuate in shape as the front support member 40 being secured to the first vertical support member 35 at a point lower than the front support member 40. While the front support member 40 and rear support member 50 have been illustrated herein as being arcuate in shape, it is contemplated within the scope of the present invention that the front support member 40 and rear support member 50 could be provided in alternate shapes.

The second side 12 of the lower frame member 10 is identically constructed as described herein for the first side 11. The second side 12 includes a front support member 60, second horizontal support member 62, second vertical support member 64 and rear support member(not particularly illustrated herein). The seat member 20 is operably coupled intermediate the first side 11 and second side 12 utilizing suitable mechanical techniques. It is contemplated within the scope of the present invention that the seat member 20 could have integral structural elements providing the cross-frame coupling of the first side 11 and second side 12 or that additional elements could be utilized to achieve the mechanical coupling of the first side 11 and second side 12. It is further contemplated within the scope of the present invention that the ambulatory aid 100 could be provided without a seat member 20.

The upper frame 15 is operably coupled to the first upright support member 80 and second upright support member 82. The upper frame 15 is configured to be moved in an upwards-downwards direction as is further discussed herein. The upper frame 15 includes first upright support member 80 and second upright support member 82. First upright support member 80 and second upright support member 82 each have a portion thereof that is disposed within the interior volume of the first vertical support member 35 and second vertical support member 64 respectively. Operably coupled to the first upright support member 80 and second upright support member 82 is the upper support assembly 90. The upper support assembly 90 includes first lateral support member 91, second lateral support member 92 and horizontal support member 93 all integrally formed in a generally square U-shape. Movement member 70 is operably coupled to the upper frame 15 and is configured to provide the upwards-downwards movement thereof. It should be understood within the scope of the present invention that the movement member 70 could be provided in various embodiments such as but not limited to hydraulic, pneumatic or electro-mechanical. The movement member 70 is operably coupled to controller 75 wherein controller 75 is configured to initiate movement of the upper frame 15 in either an upwards or downwards direction. Controller 75 is similar to a conventional joystick wherein a movement thereof provides a corresponding movement of either upwards or downwards of the upper frame member 15. It is further contemplated within the scope of the present invention that more than one controller 75 could be provided wherein an additional controller could provide power to elements such as but not limited to the wheels 95 providing either rotation or braking thereof.

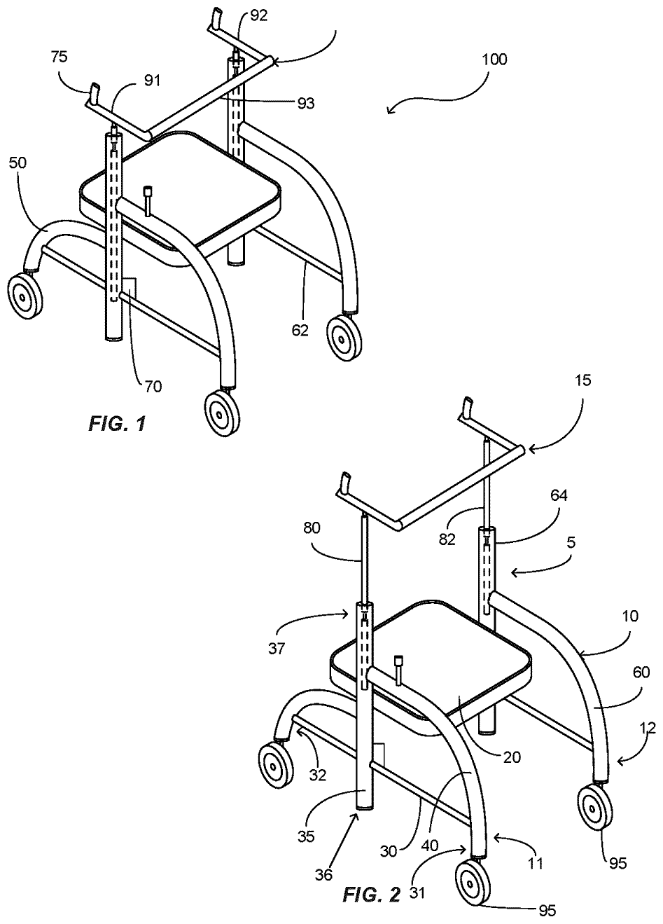

The upper frame member 15 is movable in an upwards direction so as to assist a user in a seated position on the seat member to transition to a standing position and subsequently utilize the ambulatory aid 100 for walking. A user will have their forearms engaged with the first lateral support member 91 and second lateral support member 92 wherein the upward motion thereof will provide the necessary lifting of the user of the ambulatory aid 100 so as to transition to a standing position. The first upright support member 80 and second upright support member 82 traverse within the first vertical support member 35 and second vertical support member 64 respectively. This provide the first position of the upper frame member15, illustrated herein in FIG. 1 and the second position of the upper frame member15 illustrated herein in FIG. 2. While the upper frame member 15 is illustrated in an embodiment herein, it should be understood within the scope of the present invention that the upper frame member15 could be constructed with alternate elements and in alternate shapes and still achieve the desired function herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An ambulatory aid that is configured to assist a user in moving from a first position to a second position wherein the ambulatory aid comprises:
a frame, said frame having a lower frame member and an upper frame member, said lower frame member having a first side and a second side, said first side and said second side having a void therebetween, said upper frame member being movably coupled to said lower frame member, said upper frame member extending across said void between said first side and said second side, said upper frame member being movable in an upwards-downwards direction with respect to said lower frame member;
a movement member, said movement member being operably coupled to said upper frame member, said movement member configured to facilitate the upwards-downwards movement of said upper frame member; and
a controller, said controller being mounted to said upper frame member, said controller being operably coupled to said movement member, said controller being configured as an interface for said movement member.

2. The ambulatory aid that is configured to assist a user in moving from a first position to a second position as recited in claim 1, wherein said first side of said lower frame includes a first horizontal member, said first horizontal member having a first end and a second end, said first end of said first horizontal member being operably coupled to a front support member, said second end of said first horizontal member being operably coupled to a rear support member.

3. The ambulatory aid that is configured to assist a user in moving from a first position to a second position as recited in claim 2, wherein said first side of said lower frame member include a first vertical support member, said first vertical support member being operably coupled to said first horizontal support member being perpendicular thereto extending upward therefrom.

4. The ambulatory aid that is configured to assist a user in moving from a first position to a second position as recited in claim 3, wherein said second side of said lower frame includes a second horizontal member, said second horizontal member having a first end and a second end, said first end of said second horizontal member being operably coupled to a front support member, said second end of said second horizontal member being operably coupled to a rear support member.

5. The ambulatory aid that is configured to assist a user in moving from a first position to a second position as recited in claim 4, wherein said second side of said lower frame member include a second vertical support member, said second vertical support member being operably coupled to said second horizontal support member being perpendicular thereto extending upward therefrom.

6. The ambulatory aid that is configured to assist a user in moving from a first position to a second position as recited in claim 5, wherein said upper frame member includes a first upright support member, said first upright support member being movably coupled with said first vertical support member of said lower frame.

7. The ambulatory aid that is configured to assist a user in moving from a first position to a second position as recited in claim 6, wherein said upper frame member includes a second upright support member, said second upright support member being movably coupled with said second vertical support member of said lower frame.

8. The ambulatory aid that is configured to assist a user in moving from a first position to a second position as recited in claim 7, wherein said upper frame member includes an upper support assembly, said upper support assembly consisting of a first lateral support member and a second lateral support member, said first lateral support member being operably coupled to said first upright support member, said second lateral support member being operably coupled to said second upright support member.

9. The ambulatory aid that is configured to assist a user in moving from a first position to a second position as recited in claim 8, wherein said upper support assembly further includes a horizontal support member, said horizontal support member of said upper support assembly operably coupled to said first lateral support member and said second lateral support member.

10. The ambulatory aid that is configured to assist a user in moving from a first position to a second position as recited in claim 9, wherein said upper support assembly is square U-shaped.
